(19) United States
(12) Patent Application Publication
(10) Pub. No.: US 2016/0183072 A1
(43) Pub. Date: Jun. 23, 2016

(54) ADVANCED CALL NOTIFICATION

(71) Applicants: Harish Mitty, Bangalore (IN); Muniram Krishnan, Bangalore (IN)

(72) Inventors: Harish Mitty, Bangalore (IN); Muniram Krishnan, Bangalore (IN)

(21) Appl. No.: 14/575,881

(22) Filed: Dec. 18, 2014

(51) Int. Cl. H04W 4/22; H04W 68/00; H04M 19/04; H04M 1/725; H04M 3/42; H04W 4/14; H04W 76/00

(52) U.S. Cl. CPC H04W 4/22; H04W 4/14; H04W 68/005; H04W 76/007; H04M 1/72536; H04M 3/42017; H04M 19/042

(57) ABSTRACT

Examples of systems and methods for advanced call notification are generally described herein. A system may include a communication module to receive an indication from a remote device, the indication including information identifying the remote device and an urgency value and receive a call initiated by the remote device. The system may include a processing module to determine the urgency value indicates the call is urgent, and in response to determining the call is urgent, direct the communication module to connect to the remote device.

### BACKGROUND

Etiquette often requires silencing a mobile device or not answering a call when in certain social or business circumstances. However, sometimes a call is urgent but goes unanswered, which is undesirable for both parties. Currently, when a mobile device rings with a call, there is no way to tell if the call is urgent. Also, mobile devices cannot audibly alert a user to an urgent call when the mobile device is on a silent or a vibrate mode.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a diagram illustrating a mobile device to initiate an urgent call, according to an embodiment;

FIGS. 2A and 2B are diagrams illustrating a mobile device to receive a normal call and an urgent call, according to an embodiment;

FIG. 3 is a flowchart illustrating a method for receiving an urgent call, according to an embodiment;

FIG. 4 is a diagram illustrating a mobile client device on which the configurations and techniques described herein may be deployed, according to an embodiment; and

FIG. 5 is a block diagram of a machine upon which any one or more of the techniques (e.g., methodologies) discussed herein may perform, according to an embodiment.

### DETAILED DESCRIPTION

As described above, it is often difficult or impossible to determine whether an incoming call is urgent. Other times, even when an urgent call is expected, if a mobile device to receive the urgent call is on a silent or vibrate mode, the urgent call may not be connected because a user may not notice the incoming urgent call. In other examples, an urgent call may not be answered due to circumstances such as driving, biking, attending a meeting, talking on another call, attending religious services, going on a date, etc. In these examples, a user might deliberately ignore a call that the user would accept if the user knew the call was urgent. In another example, a user may accidentally leave a phone on a silent or vibrate mode unintentionally.

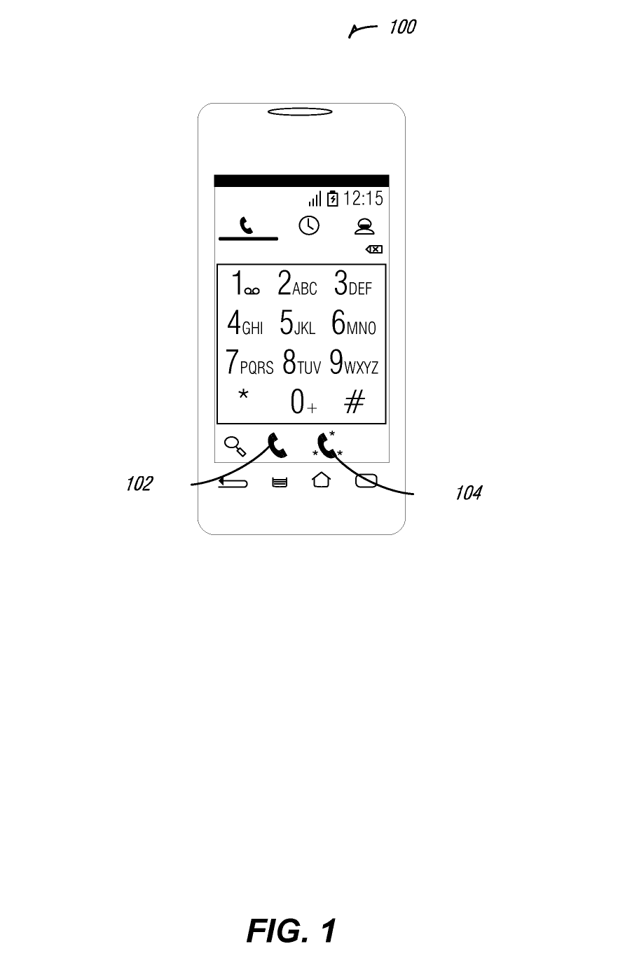

FIG. 1 shows a diagram illustrating a mobile device 100 to initiate an urgent call, according to an embodiment. In an example, the mobile device 100 includes a normal call button 102 and an urgent call button 104. The normal call button 102 and the urgent call button 104 may be physical buttons or buttons indicated on a display screen of the mobile device 100. The mobile device 100 may be used to initiate or receive an urgent call. A user may initiate a call with a remote device using the normal call button 102, which would function as a regular call. A user may also initiate a call with another a remote device using the urgent call button 104. When a call is initiated at the mobile device 100 using the urgent call button 104, the mobile device 100 may send an indication to the remote device including information identifying the remote device (e.g., the phone number associated with the mobile device 100) or an urgency value. The mobile device 100 may send an urgency value when the normal call button 102 is used to initiate a call as well. In an example, the urgency value will be 0 when the normal call button 102 is used to initiate a call and the urgency value will be 1 when the urgent call button 104 is used to initiate a call. In an example, the normal call button 102 may be a neutral color, such as white, black, grey, green, etc., and the urgent call button 104 may be a bright, contrasting, or stark color, such as red, blue, pink, etc. The urgent call button 104 may also include other visual indications to differentiate it from the normal call button 102, such as stars around a phone icon as shown in FIG. 1, arrows surrounding a phone icon, a different phone icon, etc. The urgent call button 104, or a similar urgent call icon may be displayed in different screens of the mobile device 100, such as a contacts screen, dialer screen, recent call screen, or the like.

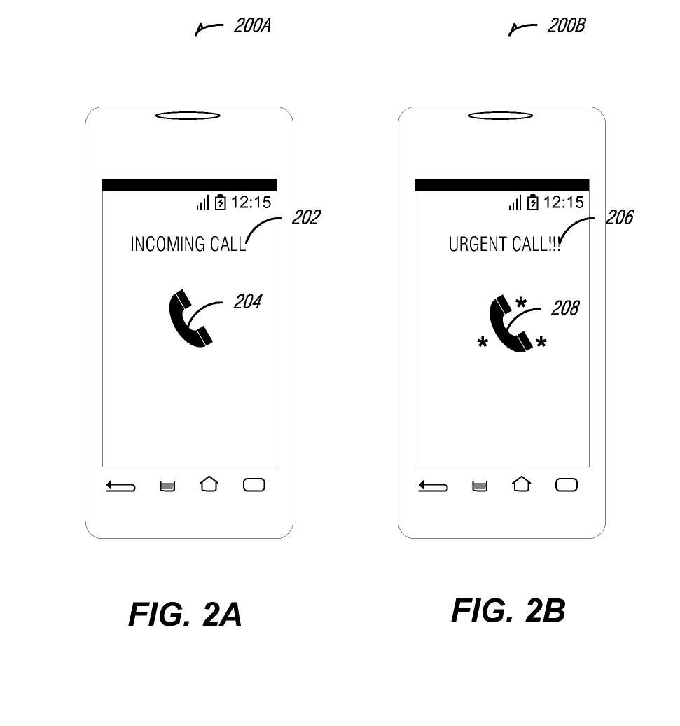

FIG. 2A shows a diagram illustrating a mobile device 200A when a normal call is received, according to an embodiment. In an example, the mobile device 200A may include a visual display of a normal call icon 204 or normal call text 202 describing the normal call.

FIG. 2B shows a mobile device 200B when an urgent call is received, according to an embodiment. The mobile device 200B may include a visual display of an urgent call icon 208 or urgent call text 206 describing the urgent call. The urgent call icon 208 may be differentiated from the normal call icon 204 using different colors, icon shapes, icons, etc. For example, when receiving a normal call, the mobile device 200A may show the normal call icon 204 in green and when receiving an urgent call, the mobile device 200B may show the urgent call icon 208 in red, where the normal call icon 204 may be in the shape of a phone and the urgent call icon 208 may be in the shape of a phone with stars around it. In another example, the background behind the urgent call icon 208 may be a different color, such as red, to signify the urgent call.

When receiving a call, a mobile device may show text describing the call. For example, when receiving a normal call, the mobile device 200A shows normal call text 202, (e.g., “INCOMING CALL”). When receiving an urgent call, the mobile device 200B may show, for example, urgent call text 206 (e.g., “URGENT CALL!!!”). The urgent call text 206 may also include information about the urgency, such as a type of urgency (e.g., “important client call,” “you forgot to pick up the kids,” “need to go to hospital,” etc.), an urgency ranking (e.g., “1—major emergency!”, “2—minor emergency”, “3—very important,” “4—time sensitive,” etc.), or the like.

In an example, when the mobile device 200B receives an urgent call, the mobile device 200B may be in a silent or vibrate mode. In this example, when the urgent call is received, the mobile device 200B may enable sound and play a ringtone, even though the mobile device is in the silent or vibrate mode. The mobile device 200B may become unsilenced when receiving the urgent call, such as by changing to a sound-enabled mode or remaining in the silent or vibrate mode, but playing the ringtone. In another example, when the mobile device 200B receives an urgent call but is already connected to a normal call (non-urgent), then the mobile device 200B may put the normal call on hold and connect to the urgent call, with or without a confirmation from a user. If the mobile device 200B is already connected to a first urgent call when it receives a second urgent call, a user may choose to put the first urgent call on hold and answer the second urgent call, or may ignore the second urgent call and remain connected to the first urgent call. In another example, the mobile device 200B may automatically connect to an urgent call, even if the mobile device 200B is already connected to another urgent call. In an example, a mobile device may be connected to one or more normal or urgent calls, and when another mobile device attempts to initiate a normal call with the mobile device, the other mobile device may receive a busy signal. In this example, when the mobile device receives an urgent call, the mobile device may override the busy signal and connect to the other mobile device. The mobile device may drop one or more of the one or more normal or urgent calls or put one or more of them on hold in order to connect to the other mobile device on the urgent call.

The mobile device 200B may include an option to disable the advanced call notification. For example, if a user does not want any calls to come in, no matter how urgent, the user may disable the advanced call notification and silence the mobile device 200B, and then no calls will cause the mobile device 200B to ring. In another example, the mobile device 200B may include a whitelist. The whitelist may represent other mobile devices from which a user may receive urgent calls. If the whitelist is activated, the mobile device 200B will receive urgent calls only from other mobile devices that are on the whitelist. In an example, when the whitelist is activated and an urgent call is initiated from another mobile device not on the whitelist, the call will appear as a normal call, such as in FIG. 2A.

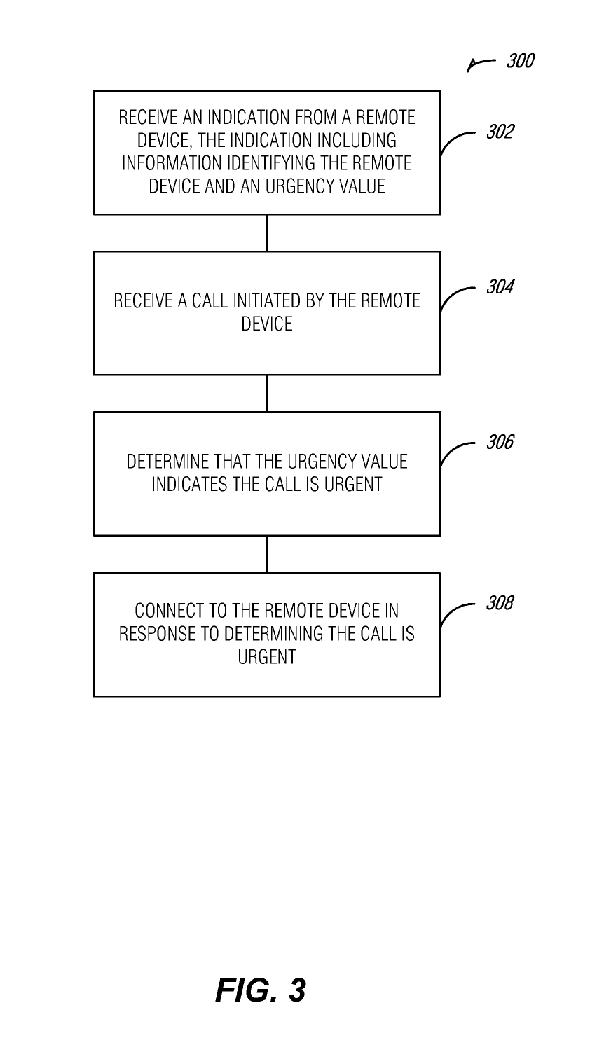

FIG. 3 shows a flowchart illustrating a method 300 for receiving an urgent call, according to an embodiment. In an example, the method 300 includes an operation 302 to receive an indication from a remote device, the indication including information identifying the remote device and an urgency value. The indication may be received in a number of ways. For example, the indication may be sent by the remote device using a Short Message Service (SMS) and received as a SMS message. In another example, the indication may be received using a mobile application. The indication may also be received during network setup of a call, such as in a network setup message. For example, the network setup message may include a CC_Setup message in a Global System for Mobile Communication (GSM) network second generation (2G). In another example, the network setup message may include a RRC Connection Request in a wireless network, such as a 3rd Generation Partnership Project (3GPP) long term evolution (LTE) or LTE-advanced network. A message may be sent using a specification, such as 3GPP 24.008 Section 9.3.23.1 “Setup (mobile terminated call establishment)” or Section 9.3.23.1.12 “User-User” IEI (e.g., version 8 or later). Other network setup messages or network configuration blocks may be used for sending or receiving the indication.

In an example implementation, a change to Application Processor (AP) of an Android-based phone may be made to allow a message with urgency information to be sent and received. For example, the Radio Interface Layer (RIL) of the Android framework may be modified to include processing and relaying the urgency information. In another example, a Baseband Processor (BP) protocol stack may be modified to allow urgency information to be sent and received, such as with a network setup message as described above. An example may include a Mobile Originating (MO) party, such as a mobile device, indicating that an initiated call is urgent, and a Mobile Terminating (MT) party, such as a remote device, receiving the initiated call and the urgency information based on a field in a user-user information element (IE) or information element identifier (IEI).

The urgency value may include an urgency flag, such as a Boolean flag where if the Boolean flag is set to 1, the call is urgent and if the Boolean flag is set to 0, the call is not urgent. In an example, the urgency value include a value in a range of urgency values. The range of urgency values may include different levels of urgency, such as normal, important, critical, or extreme emergency, which may include situations such as a regular call, a call about child care, a call about an injury, or a call about mortal danger, respectively. In another example, the urgency value includes text conveying a type of urgency. The text may be selected by a user from a list or typed in by the user. The text may be displayed using a type of urgency from a numbered list or entered text.

The method 300 may include an operation 304 to receive a call initiated by the remote device. In an example, receiving the call includes receiving the call using a mobile application. The mobile application to receive the call may be the same mobile application used to receive the indication, as described above. In another example, the mobile application to receive the call may be used with the other ways of receiving the indication (e.g., network message or SMS message), or the mobile application to receive the call may be a different mobile application than the one to receive the indication.

In an example, the method 300 includes an operation 306 to determine that the urgency value indicates the call is urgent. In an example, determining the call is urgent may include determining the remote device is on a whitelist using the information identifying the remote device. For example, a user at the remote device may select a whitelist of phone numbers from which the user will allow urgent calls. A whitelist may be a list of names, numbers, devices, device identifications, or the like, selected (automatically or by a user) for allowing urgent calls. The whitelist may be used in conjunction with the urgency value and the information identifying the remote device to determine if the call is urgent. The information identifying the remote device may include a name, number, device, device identification, or the like, which may be compared to corresponding information in the whitelist. If there is a match, the call may be urgent. In another example, the call may be determined to be urgent if the urgency value indicates the call is urgent without determining if the information identifying the remote device corresponds with information in the whitelist. For example, a user may turn on or off a whitelist feature in an application or mobile device settings, or the whitelist feature may be automatically turned on or off without user input. In an illustrative example, a user may include a spouse, parent, and child in a whitelist and when the spouse, parent, or child calls using an urgent call button from the spouse's, parent's, or child's mobile device, the user's mobile device will recognize the information identifying the spouse's, parent's, or child's mobile device as corresponding to information in the whitelist. The urgent call will also include an urgency value indicating the call is urgent, and the user's device will determine that the call is urgent based on the urgency value and the information identifying the spouse's, parent's, or child's mobile device. In another illustrative example using the same whitelist, if a person other than the spouse, parent, or child calls the user, even if the person attempts to initiate an urgent call, the user's mobile device will not identify the call as urgent since the information identifying the person's mobile device will not correspond to information in the whitelist. If a whitelist is set up, then in order to have a user's device determine an incoming call is urgent, the urgency value will indicate the call is urgent and the information identifying the remote device will correspond to information in the whitelist. If a whitelist is not set up, then to determine an incoming call is urgent, a user's mobile device may use the urgency value without using the information identifying the remote device.

The method 300 may include an operation 308 to connect to the remote device in response to determining the call is urgent. In an example, connecting to the remote device includes connecting to the remote device in response to receiving confirmation from a user to connect to the remote device. Another example may include receiving a call rejection indication from a user, and in response to receiving the call rejection indication, disconnecting from the remote device. After the call is determined to be urgent, a user may receive a prompt, audible alert, visible notification, or the like, indicating that the call is urgent. The method 300 may include displaying a visual notification of the call, the visual notification including urgency information. The urgency information may include the type of urgency, text related to the urgency, an urgency value, rank, or type, a visual indication, such as a color (e.g., red) or symbol (e.g., stars), or the like. The user may choose to confirm or reject the call. If the user confirms the call, the call may be connected and if the user rejects the call, the call may be disconnected or not connected in the first place. In another example, though the user rejects the call, the call may be connected (or remain connected) anyway, if the call is urgent. In yet another example, if the user rejects the call, the method 300 may include displaying a prompt to ask the user to confirm the decision, and the prompt may include information about the urgency of the call.

When the call is determined to be urgent, the method 300 may include connecting to the remote device without user input. The call may be connected with a delay, such as a delay to alert the user that an incoming urgent call is about to be connected. The call may be connected automatically, as soon as possible, with or without a visual or audio alert. In another example, the call may be connected even though the user is on another call. In this example, the method 300 may include interrupting the other call, either by putting the other call on hold or disconnecting the other call, and the user may receive the urgent call. The urgent call may connect automatically, give the user a chance to accept or reject the call, or any of the other options described above.

In an example, the method 300 may include, in response to receiving the call, playing a ringtone. The ringtone may be unique to urgent calls. A user may select a unique ringtone or a unique ringtone may be selected automatically. In an example, the ringtone may include urgency information. The urgency information my include audible text, such as text indicating the call is urgent, a type of urgency, a level or rank of urgency, information about the remote device, or the like. The method 300 may include unsilencing the phone before playing the ringtone. In an illustrative example, a user may select a silent or vibrate mode on a mobile device. In this example, when the mobile device receives a call determined to be urgent, the mobile device may play a ringtone even though the user has selected the silent or vibrate mode. The mobile device may change to a non-silenced mode or may leave the phone in an silent mode for other functions, but play the ringtone for the urgent call. In another example, an urgent call may be sent to or from or received at or from an Internet of Things device.

In an example, a mobile device may initiate an urgent call without a data or network connection or with a limited data or network connection. For example, the mobile device may not be connected to the internet but may initiate an urgent call. The limited or lack of data access may be due to network availability or user preferences or settings. In an illustrative example, a user may set the user's mobile device to a call-only mode (e.g., disable all data networks) to save battery but may make an urgent call. In another example, a mobile device may receive an urgent call without a data or network connection or with a limited data or network connection. For example, the mobile device may not be connected to the internet but may receive an urgent call or an indication of an urgent call.

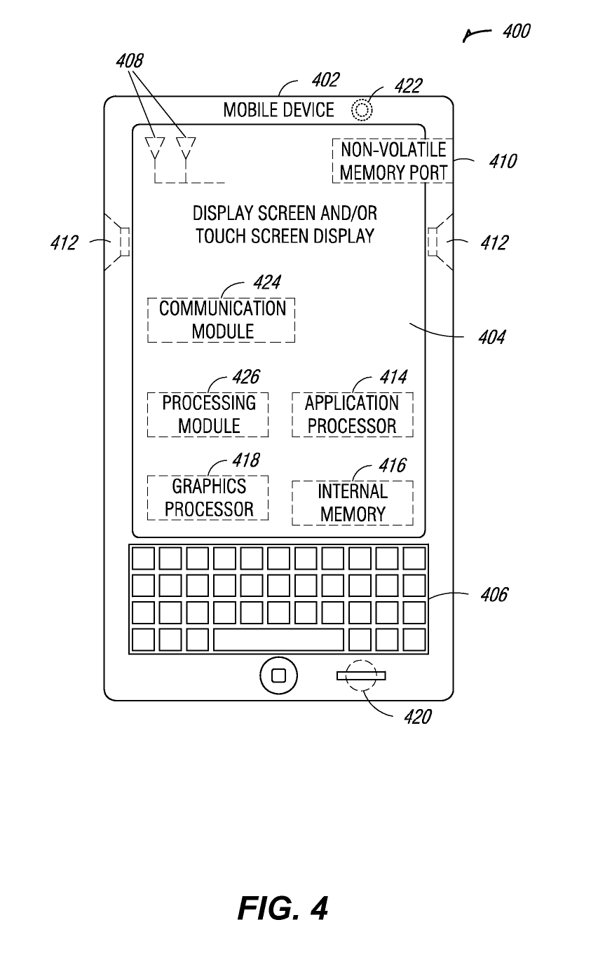

FIG. 4 is a diagram illustrating a mobile client device on which the configurations and techniques described herein may be deployed, according to an embodiment. FIG. 4 provides an example illustration of a mobile device 400, such as a user equipment (UE), a mobile station (MS), a mobile wireless device, a mobile communication device, a tablet, a handset, or other type of mobile wireless computing device. The mobile device 400 may include one or more antennas 408 within housing 402 that are configured to communicate with a hotspot, base station (BS), an eNB, or other type of WLAN or WWAN access point. The mobile device may be configured to communicate using multiple wireless communication standards, including standards selected from 3GPP LTE, WiMAX, High Speed Packet Access (HSPA), Bluetooth, and Wi-Fi standard definitions. The mobile device 400 may communicate using separate antennas for each wireless communication standard or shared antennas for multiple wireless communication standards. The mobile device 400 may communicate in a WLAN, a WPAN, and/or a WWAN.

FIG. 4 also provides an illustration of a microphone 420 and one or more speakers 412 that may be used for audio input and output from the mobile device 400. A display screen 404 may be a liquid crystal display (LCD) screen, or other type of display screen such as an organic light emitting diode (OLED) display. The display screen 404 may be configured as a touch screen. The touch screen may use capacitive, resistive, or another type of touch screen technology. An application processor 414 and a graphics processor 418 may be coupled to internal memory 416 to provide processing and display capabilities. A non-volatile memory port 410 may also be used to provide data input/output options to a user. The non-volatile memory port 410 may also be used to expand the memory capabilities of the mobile device 400. A keyboard 406 may be integrated with the mobile device 400 or wirelessly connected to the mobile device 400 to provide additional user input. A virtual keyboard may also be provided using the touch screen. A camera 422 located on the front (display screen) side or the rear side of the mobile device 400 may also be integrated into the housing 402 of the mobile device 400.

In an example, the mobile device 400 may include a communication module 424 or a processing module 426. The communication module 424 may receive an indication from a remote device, the indication including information identifying the remote device and an urgency value. The communication module 424 may receive a call initiated by the remote device. The processing module 426 may determine the urgency value indicates the call is urgent. In an example, the processing module 426 may, in response to determining the call is urgent, direct the communication module to connect to the remote device.

In an example, the communication module 424 may play a ringtone. The ringtone may be unique to urgent calls or include urgency information. To play the ringtone, the communication module 424 may first unsilence the phone. In another example, the communication module 424 may receive the indication as a Short Message Service (SMS) message, using a mobile application, or using a network configuration or setup message. The communication module 424 may receive the call using a mobile application, and the mobile application may be used with any of the above ways for the communication module 424 to receive the indication, including separate mobile applications for the indication and the call. In an example, the communication module 424 may receive the direction from the processing module 426 to connect to the remote device. The communication module 424 may receive a call rejection indication from a user, and in response to the call rejection indication, not connect to the remote device. In another example, the communication module 424 may connect to the remote device. The communication module 424 may connect to the remote device with or without user input. In yet another example, the communication module 424 may interrupt another call.

In an example, the processing module 426 may use the information identifying the remote device to determine the remote device is on a whitelist. In another example, the processing module 426 may display a visual notification. The processor module 426 may receive confirmation from a user to connect to the remote device.

In another example, the communication module 424 may send an indication to a second UE, the indication including information identifying the first UE and an urgency value. The communication module 424 may initiate a call to the second UE, wherein the urgency value indicates the call is urgent. In an example, the communication module 424 may receive acceptance of the initiated call from the second UE. The communication module 424 may connect to the second UE. In another example, the communication module 424 may send the indication in response to receiving a confirmation from a user that the call is urgent. The communication module 424 may receive a selection of text conveying a type of urgency from a user and may send the text conveying the type of urgency. In yet another example, the communication module 424 may receive a selection of the urgency value from a user.

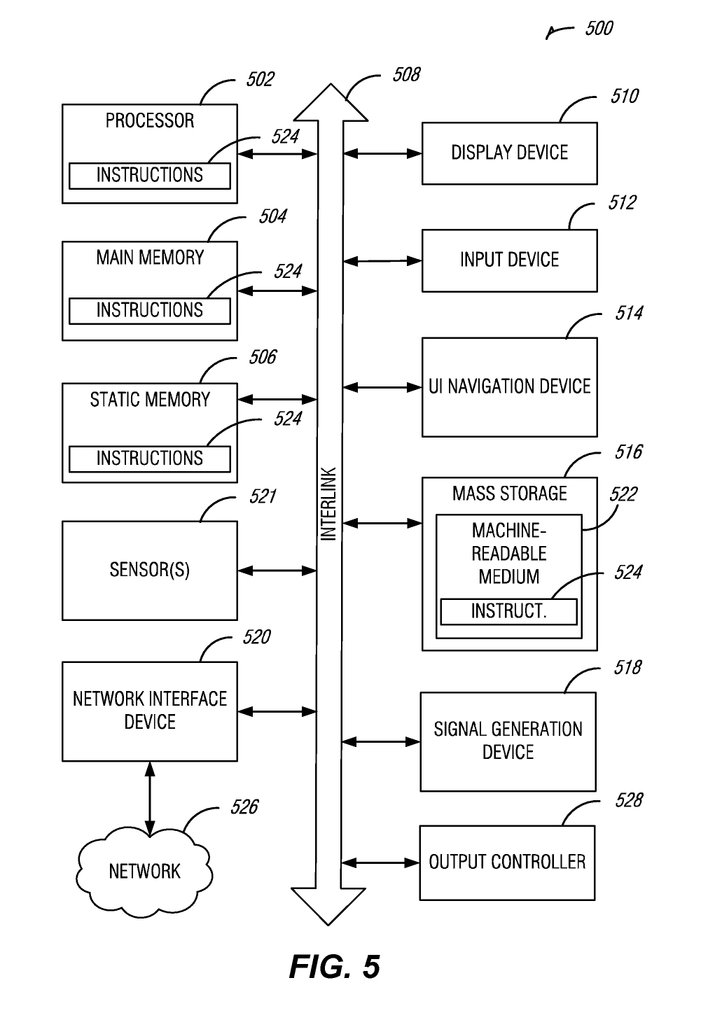

FIG. 5 is a block diagram of a machine 500 upon which any one or more of the techniques (e.g., methodologies) discussed herein may perform, according to an embodiment. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, alphanumeric input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 that is non-transitory on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks. The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### VARIOUS NOTES & EXAMPLES

Each of these non-limiting examples can stand on its own, or can be combined in various permutations or combinations with one or more of the other examples.

Example 1 includes the subject matter embodied by a mobile device for advanced call notification comprising: a communication module to: receive an indication from a remote device, the indication including information identifying the remote device and an urgency value, and receive a call initiated by the remote device, and a processing module to: determine the urgency value indicates the call is urgent, and in response to determining the call is urgent, direct the communication module to connect to the remote device.

In Example 2, the subject matter of Example 1 can optionally include wherein to determine the call is urgent, the processing module is to use the information identifying the remote device to determine the remote device is on a whitelist.

In Example 3, the subject matter of one or any combination of Examples 1-2 can optionally include wherein in response to receiving the call initiated by the remote device, the communication module is to play a ringtone.

In Example 4, the subject matter of one or any combination of Examples 1-3 can optionally include wherein the ringtone is unique to urgent calls.

In Example 5, the subject matter of one or any combination of Examples 1-4 can optionally include wherein the ringtone includes urgency information.

In Example 6, the subject matter of one or any combination of Examples 1-5 can optionally include wherein to play the ringtone, the communication module is to first unsilence the phone.

In Example 7, the subject matter of one or any combination of Examples 1-6 can optionally include wherein to receive the indication, the communication module is to receive a Short Message Service (SMS) message.

In Example 8, the subject matter of one or any combination of Examples 1-7 can optionally include wherein to receive the indication, the communication module is to receive the indication using a mobile application.

In Example 9, the subject matter of one or any combination of Examples 1-8 can optionally include wherein to receive the call, the communication module is to receive the call using a mobile application.

In Example 10, the subject matter of one or any combination of Examples 1-9 can optionally include wherein to direct the communication module to connect to the remote device, the processor is to receive confirmation from a user to connect to the remote device.

In Example 11, the subject matter of one or any combination of Examples 1-10 can optionally include wherein the communication module is to receive a call rejection indication from a user, and in response to the call rejection indication, not connect to the remote device.

In Example 12, the subject matter of one or any combination of Examples 1-11 can optionally include wherein the communication module is to connect to the remote device.

In Example 13, the subject matter of one or any combination of Examples 1-12 can optionally include wherein to connect to the remote device, the communication module is to connect to the remote device without user input.

In Example 14, the subject matter of one or any combination of Examples 1-13 can optionally include wherein to connect to the remote device, the communication module is to interrupt another call.

In Example 15, the subject matter of one or any combination of Examples 1-14 can optionally include wherein in response to determining the urgency value indicates the call is urgent, the processing module is to display a visual notification.

In Example 16, the subject matter of one or any combination of Examples 1-15 can optionally include wherein the urgency value includes a value in a range of urgency values.

In Example 17, the subject matter of one or any combination of Examples 1-16 can optionally include wherein the urgency value includes text conveying a type of urgency.

Example 18 includes the subject matter embodied by a first mobile device for advanced call notification comprising: a communication module to: send an indication to a second mobile device, the indication including information identifying the first mobile device and an urgency value, initiate a call to the second mobile device, wherein the urgency value indicates the call is urgent, receive acceptance of the initiated call from the second mobile device, and present a notification that the call is urgent.

In Example 19, the subject matter of Example 18 can optionally include wherein to send the indication, the communication module is to send the indication in response to receiving a confirmation from a user that the call is urgent.

In Example 20, the subject matter of one or any combination of Examples 18-19 can optionally include wherein the communication module is to receive a selection of text conveying a type of urgency from a user.

In Example 21, the subject matter of one or any combination of Examples 18-20 can optionally include wherein to send the indication, the communication module is to send the selection of text conveying the type of urgency to the second mobile device.

In Example 22, the subject matter of one or any combination of Examples 18-21 can optionally include wherein the communication module is to receive the urgency value from a user.

In Example 23, the subject matter of one or any combination of Examples 18-22 can optionally include wherein the urgency value includes a value in a range of urgency values.

In Example 24, the subject matter of one or any combination of Examples 18-23 can optionally include wherein the communication module is to connect to the second mobile device.

Example 25 includes the subject matter embodied by a method performed by a mobile device comprising: receiving an indication from a remote device, the indication including information identifying the remote device and an urgency value, receiving a call initiated by the remote device, determining that the urgency value indicates the call is urgent, and in response to determining the call is urgent, presenting a notification that the call is urgent.

In Example 26, the subject matter of Example 25 can optionally include wherein determining the call is urgent includes determining the remote device is on a whitelist using the information identifying the remote device.

In Example 27, the subject matter of one or any combination of Examples 25-26 can optionally include further comprising playing a ringtone in response to receiving the call.

In Example 28, the subject matter of one or any combination of Examples 25-27 can optionally include wherein the ringtone is unique to urgent calls.

In Example 29, the subject matter of one or any combination of Examples 25-28 can optionally include wherein the ringtone includes urgency information.

In Example 30, the subject matter of one or any combination of Examples 25-29 can optionally include further comprising unsilencing the phone before playing the ringtone.

In Example 31, the subject matter of one or any combination of Examples 25-30 can optionally include wherein receiving the indication includes receiving a Short Message Service (SMS) message.

In Example 32, the subject matter of one or any combination of Examples 25-31 can optionally include wherein receiving the indication includes receiving the indication using a mobile application.

In Example 33, the subject matter of one or any combination of Examples 25-32 can optionally include wherein receiving the call includes receiving the call using a mobile application.

In Example 34, the subject matter of one or any combination of Examples 25-33 can optionally include further comprising connecting to the remote device.

In Example 35, the subject matter of one or any combination of Examples 25-34 can optionally include wherein connecting to the remote device includes connecting to the remote device in response to receiving confirmation from a user to connect to the remote device.

In Example 36, the subject matter of one or any combination of Examples 25-35 can optionally include wherein connecting to the remote device includes connecting to the remote device without user input.

In Example 37, the subject matter of one or any combination of Examples 25-36 can optionally include wherein connecting to the remote device includes interrupting another call.

In Example 38, the subject matter of one or any combination of Examples 25-37 can optionally include further comprising receiving a call rejection indication from a user, and in response to receiving the call rejection indication, not connecting to the remote device.

In Example 39, the subject matter of one or any combination of Examples 25-38 can optionally include wherein presenting the notification that the call is urgent includes displaying a visual notification of the call, the visual notification including urgency information.

In Example 40, the subject matter of one or any combination of Examples 25-39 can optionally include wherein the urgency value includes a value in a range of urgency values.

In Example 41, the subject matter of one or any combination of Examples 25-40 can optionally include wherein the urgency value includes text conveying a type of urgency.

Example 42 includes at least one machine-readable medium including instructions for receiving information, which when executed by a machine, cause the machine to perform any of the methods of Examples 25-41.

Example 43 includes an apparatus comprising means for performing any of the methods of Examples 25-41.

Example 44 includes the subject matter embodied by an apparatus comprising: means for receiving an indication from a remote device, the indication including information identifying the remote device and an urgency value, means for receiving a call initiated by the remote device, means for determining that the urgency value indicates the call is urgent, and in response to determining the call is urgent, means for presenting a notification that the call is urgent.

In Example 45, the subject matter of Example 44 can optionally include wherein means for determining the call is urgent includes means for determining the remote device is on a whitelist using the information identifying the remote device.

In Example 46, the subject matter of one or any combination of Examples 44-45 can optionally include further comprising means for playing a ringtone in response to receiving the call.

In Example 47, the subject matter of one or any combination of Examples 44-46 can optionally include wherein the ringtone is unique to urgent calls.

In Example 48, the subject matter of one or any combination of Examples 44-47 can optionally include wherein the ringtone includes urgency information.

In Example 49, the subject matter of one or any combination of Examples 44-48 can optionally include further comprising means for unsilencing the phone before playing the ringtone.

In Example 50, the subject matter of one or any combination of Examples 44-49 can optionally include wherein means for receiving the indication includes means for receiving a Short Message Service (SMS) message.

In Example 51, the subject matter of one or any combination of Examples 44-50 can optionally include wherein means for receiving the indication includes means for receiving the indication using a mobile application.

In Example 52, the subject matter of one or any combination of Examples 44-51 can optionally include wherein means for receiving the call includes means for receiving the call using a mobile application.

In Example 53, the subject matter of one or any combination of Examples 44-52 can optionally include further comprising connecting to the remote device.

In Example 54, the subject matter of one or any combination of Examples 44-53 can optionally include wherein means for connecting to the remote device includes means for connecting to the remote device in response to receiving confirmation from a user to connect to the remote device.

In Example 55, the subject matter of one or any combination of Examples 44-54 can optionally include wherein means for connecting to the remote device includes means for connecting to the remote device without user input.

In Example 56, the subject matter of one or any combination of Examples 44-55 can optionally include wherein means for connecting to the remote device includes means for interrupting another call.

In Example 57, the subject matter of one or any combination of Examples 44-56 can optionally include further comprising means for receiving a call rejection indication from a user, and in response to receiving the call rejection indication, means for not connecting to the remote device.

In Example 58, the subject matter of one or any combination of Examples 44-57 can optionally include wherein means for presenting the notification that the call is urgent includes means for displaying a visual notification of the call, the visual notification including urgency information.

In Example 59, the subject matter of one or any combination of Examples 44-58 can optionally include wherein the urgency value includes a value in a range of urgency values.

In Example 60, the subject matter of one or any combination of Examples 44-59 can optionally include wherein the urgency value includes text conveying a type of urgency.

Example 61 includes the subject matter embodied by a method performed by a first mobile device comprising: sending an indication to a second mobile device, the indication including information identifying the first mobile device and an urgency value, initiating a call to the second mobile device, wherein the urgency value indicates the call is urgent, receiving acceptance of the initiated call from the second mobile device, and presenting a notification that the call is urgent.

In Example 62, the subject matter of Example 61 can optionally include wherein sending the indication includes sending the indication in response to receiving a confirmation from a user that the call is urgent.

In Example 63, the subject matter of one or any combination of Examples 61-62 can optionally include further comprising receiving a selection of text conveying a type of urgency from a user.

In Example 64, the subject matter of one or any combination of Examples 61-63 can optionally include wherein sending the indication includes sending the selection of text conveying the type of urgency to the second mobile device.

In Example 65, the subject matter of one or any combination of Examples 61-64 can optionally include further comprising receiving the urgency value from a user.

In Example 66, the subject matter of one or any combination of Examples 61-65 can optionally include wherein the urgency value includes a value in a range of urgency values.

In Example 67, the subject matter of one or any combination of Examples 61-66 can optionally include further comprising connecting to the second mobile device.

Example 68 includes at least one machine-readable medium including instructions for receiving information, which when executed by a machine, cause the machine to perform any of the methods of Examples 61-67.

Example 69 includes an apparatus comprising means for performing any of the methods of Examples 61-67.

Example 70 includes the subject matter embodied by an apparatus comprising: means for sending an indication to a mobile device, the indication including information identifying the apparatus and an urgency value, means for initiating a call to the second mobile device, wherein the urgency value indicates the call is urgent, means for receiving acceptance of the initiated call from the second mobile device, and means for presenting a notification that the call is urgent.

In Example 71, the subject matter of Example 70 can optionally include wherein means for sending the indication includes means for sending the indication in response to receiving a confirmation from a user that the call is urgent.

In Example 72, the subject matter of one or any combination of Examples 70-71 can optionally include further comprising means for receiving a selection of text conveying a type of urgency from a user.

In Example 73, the subject matter of one or any combination of Examples 70-72 can optionally include wherein means for sending the indication includes means for sending the selection of text conveying the type of urgency to the second mobile device.

In Example 74, the subject matter of one or any combination of Examples 70-73 can optionally include further comprising means for receiving the urgency value from a user.

In Example 75, the subject matter of one or any combination of Examples 70-74 can optionally include wherein the urgency value includes a value in a range of urgency values.

In Example 76, the subject matter of one or any combination of Examples 70-75 can optionally include further comprising means for connecting to the second mobile device.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A mobile device comprising:
a communication module to:
receive an indication from a remote device, the indication including information identifying the remote device and an urgency value; and
receive a call initiated by the remote device; and
a processing module to:
determine the urgency value indicates the call is urgent; and
in response to determining the call is urgent, direct the communication module to connect to the remote device.

2. The mobile device of claim 1, wherein to determine the call is urgent, the processing module is to use the information identifying the remote device to determine the remote device is on a whitelist.

3. The mobile device of claim 1, wherein in response to receiving the call initiated by the remote device, the communication module is to play a ringtone.

4. The mobile device of claim 3, wherein the ringtone is unique to urgent calls.

5. The mobile device of claim 3, wherein the ringtone includes urgency information.

6. The mobile device of claim 3, wherein to play the ringtone, the communication module is to first unsilence the phone.

7. The mobile device of claim 1, wherein to receive the indication, the communication module is to receive a Short Message Service (SMS) message.

8. The mobile device of claim 1, wherein to receive the indication, the communication module is to receive the indication using a mobile application.

9. The mobile device of claim 1, wherein to receive the call, the communication module is to receive the call using a mobile application.

10. The mobile device of claim 1, wherein to direct the communication module to connect to the remote device, the processor is to receive confirmation from a user to connect to the remote device.

11. The mobile device of claim 1, wherein the communication module is to receive a call rejection indication from a user, and in response to the call rejection indication, not connect to the remote device.

12. The mobile device of claim 1, wherein the communication module is to connect to the remote device.

13. The mobile device of claim 12, wherein to connect to the remote device, the communication module is to connect to the remote device without user input.

14. The mobile device of claim 12, wherein to connect to the remote device, the communication module is to interrupt another call.

15. The mobile device of claim 1, wherein in response to determining the urgency value indicates the call is urgent, the processing module is to display a visual notification.

16. The mobile device of claim 1, wherein the urgency value includes a value in a range of urgency values.

17. The mobile device of claim 1, wherein the urgency value includes text conveying a type of urgency.

18. A method performed by a mobile device comprising:
receiving an indication from a remote device, the indication including information identifying the remote device and an urgency value;
receiving a call initiated by the remote device;
determining that the urgency value indicates the call is urgent; and
in response to determining the call is urgent, connecting to the remote device.

19. The method of claim 18, wherein determining the call is urgent includes determining the remote device is on a whitelist using the information identifying the remote device.

20. The method of claim 18, wherein receiving the indication includes receiving a Short Message Service (SMS) message.

21. The method of claim 18, further comprising receiving a call rejection indication from a user, and in response to receiving the call rejection indication, not connecting to the remote device.

22. At least one non-transitory machine-readable medium including instructions for receiving information, which when executed by a machine, cause the machine to:
receive an indication from a remote device, the indication including information identifying the remote device and an urgency value;
receive a call initiated by the remote device;
determine that the urgency value indicates the call is urgent; and
in response to determining the call is urgent, connecting to the remote device.

23. The at least one non-transitory machine-readable medium of claim 22, wherein operations to determine that the urgency value indicates the call is urgent include operations to determine the remote device is on a whitelist using the information identifying the remote device.

24. (canceled)

25. The at least one non-transitory machine-readable medium of claim 22, wherein operations to connect to the remote device include operations to interrupt another call.
